(19) United States
(12) Patent Application Publication
(10) Pub. No.: US 2019/0106355 A1
(43) Pub. Date: Apr. 11, 2019

(54) METHOD FOR TINTING GLASS LENSES AND RELATED GLASS LENSES

(71) Applicant: LUXOTTICA S.R.L., Agordo (IT)

(72) Inventors: Omar GRASSO, Chivasso (IT); Elti CATTARUZZA, Pordenone (IT); Marco MARDEGAN, Trivignano (IT)

(73) Assignee: LUXOTTICA S.R.L., Agordo (IT)

(21) Appl. No.: 16/097,116

(22) PCT Filed: Apr. 28, 2017
(86) PCT No.: PCT/EP2017/060162

§ 371 Date: Oct. 26, 2018

(30) Foreign Application Priority Data
Apr. 29, 2016 (IT) 102016000043786

(51) Int. Cl. C03C 21/00; B29D 11/00

(52) U.S. Cl. CPC C03C 21/005; C03C 21/002; C03C 23/007; B29D 11/0073; B29D 11/00913

(57) ABSTRACT

A method for tinting glass lenses, comprising the immersion of a glass lens in a bath comprising at least one salt constituted by a cation selected from the group constituted by a transition metal, a metal of the p block of the periodic table, a rare earth metal, and by an anion selected from the group constituted by a halide, a sulfate, a nitrate; the tinting salt is mixed with another salt constituted by a cation selected from the group constituted by an alkaline metal, an alkaline earth metal, and by an anion selected from the group constituted by a halide, a sulfate, a nitrate.

The present invention relates to a method for tinting glass lenses and to the glass lenses obtained with the method.

The world of glasses is a meeting point between technology and creativity. Often technology is in the service of creativity and takes on the burden of allowing maximum variance of shapes, materials, colors and finishes to the creators of the product.

As regards lenses for glasses, and in particular lenses for sunglasses, the materials used are various and have different prerogatives, and the technical limitations of the various materials define the scope of their application. If one wishes to divide this world into macrocategories depending on chemical composition, one deals with two types of materials: organic materials, particularly polymers, and mineral glass.

Polymers have various advantages, including low weight, very low production costs, unbreakability and the possibility to obtain a great variety of shapes, dimensions and tints of the lens.

Glass has the advantage of the appeal of the traditional material for making lenses and a much higher scratch resistance and therefore durability of the glasses. However, it is heavier, it has a lower impact resistance, and its rigidity limits its application in large frames or masks.

Furthermore, the variety of tints of glass is in itself far more limited and less controllable than that which can be given to plastic lenses.

Currently in fact there are no tinting agents capable of tinting glass at will, since the tints of the glass are provided by species which are chemically bonded to the matrix of the glass itself and therefore are not always predictable exactly beforehand. Moreover, impurities have a fundamental role. The development of new tints for glass is therefore rendered complicated by its very nature.

Many technologies have been conceived so far in order to obviate the limitations of mass tinting at the casting level, including those of PVD treatments (from the English acronym “Physical Vapor Deposition”) and of hydrogen firing.

They provide for tinting the glass in the final stages of its production, after casting, pressing, polishing and sometimes even shaping.

However, they do not solve sufficiently the problem of the controllability and variety of the tinting of glass and in fact the variety of tints allowed by plastic still remains very remote for glass.

For example, the hydrogen tinting method (“hydrogen firing”) provides for tinting with gaseous hydrogen in a controlled atmosphere. This method has high costs, difficulties in integration with the method for the production of the lenses, and problems related to workplace safety. This method in fact provides for the use of hydrogen, a gas which, differently from others, has the characteristic of warming as a consequence of expansion, for example in case of accidental leaks, and of forming explosive mixtures with air.

However, other tinting methods, such as laminating the glass with tinted films, are much more complicated processes, which inevitably entail a higher final lens cost due to the necessary lamination of the lens, which requires raw material in twice the amount, and a double processing, since two polished glass menisci instead of one are needed to provide each lens.

The aim of the present invention is to provide a method for tinting glass lenses that solves the technical problems described above, obviates the drawbacks and overcomes the limitations of the background art.

Within this aim, an object of the present invention is to provide a method for tinting glass lenses that allows to expand the choice of tints available starting from normally commercially available glass, with a method that is simple and competitive with respect to already known methods.

A further object of the present invention is to provide a method for tinting glass lenses that is capable of giving the greatest assurances of reliability and safety in use.

This aim, as well as these and other objects which will become better apparent hereinafter, are achieved by a method for tinting glass lenses, comprising the immersion of a glass lens in a bath comprising at least one salt constituted by a cation selected from the group constituted by a transition metal, a metal of the p block of the periodic table, a rare earth metal, and by an anion selected from the group constituted by a halide, a sulfate, a nitrate, the temperature of said bath being selected in an interval comprised between 350° C. and 650° C., the duration of the immersion of said lens in said bath being selected in a time interval comprised between 1 minute and 20 hours, the concentration of said at least one salt being selected in an interval comprised between 0.1% and 70% by weight with respect to the total weight of said bath, the selection of said temperature, of said duration of the immersion and of said composition determining the intensity of the tinting of said lens.

Further characteristics and advantages of the invention will become better apparent from the description provided in detail herein.

The method for tinting glass lenses according to the invention comprises the immersion of a glass lens in a bath that comprises at least one salt, also termed tinting salt hereinafter, which is constituted by a cation that is selected from the group constituted by a transition metal, a metal of the p block of the periodic table, a rare earth metal, and an anion selected from the group constituted by a halide, a sulfate, a nitrate. The tinting salt is mixed with another salt constituted by a cation selected from the group constituted by an alkaline metal, an alkaline earth metal, and by an anion selected from the group constituted by a halide, a sulfate, a nitrate.

The temperature of the bath is selected in an interval comprised between 350° C. and 650° C., the duration of the immersion of the lens in the bath is selected in a time interval comprised between 1 minute and 20 hours, while the concentration of said tinting salt is selected in an interval comprised between 0.1% and 70% by weight with respect to the total weight of the bath. The selection of the temperature of the bath, of the duration of the immersion of the lens in the bath and of the concentration of the salt in the bath determine the tinting intensity of the lens.

By immersing the lens in a bath that comprises said tinting salt it is in fact possible to introduce in the glass of the lens chemical species which in the glassy matrix give rise to a tinting. By controlling the temperature, the times and the composition it is possible to control the intensity of the tinting that can be obtained from the immersion of the lens in the bath. Essentially, the temperature, the times and the composition are parameters the variation of which, within said intervals, allows to modify the tinting of the glass lens.

The tinting salt can be selected on the basis of its tinting effectiveness, cost, and thermal and chemical stability.

Advantageously, said tinting salt is copper sulfate.

Advantageously, the temperature of the bath is selected in an interval comprised between 500° C. and 650° C. Preferably, the temperature of the bath can be approximately 530° C.

Advantageously, the concentration of said salt is selected in an interval comprised between 30% and 70% by weight with respect to the total weight of the bath. Preferably, the salt concentration can be approximately equal to 48%.

Advantageously, the duration of the immersion of the lens in the bath is selected in a time interval comprised between 1 minute and 10 hours. Preferably, the duration can be approximately equal to 30 minutes.

Advantageously, the bath further comprises sodium sulfate. The method for tinting lenses can also comprise the immersion of the lens in a tempering bath which comprises at least potassium nitrate. In this manner ,the lens can be not only tinted but also tempered in two different steps.

Advantageously, the temperature of the tempering bath is selected in an interval comprised between 400° C. and 500° C. and preferably equal to approximately 450° C., while the duration of the immersion of the lens in the tempering bath is selected in a time interval comprised between 8 hours and 18 hours, and preferably equal to approximately 9 hours or approximately 16 hours.

The chemical tempering process, in fact, by means of the interaction of the hot glass with molten potassium nitrate, utilizes the sodium-potassium ion exchange, in which initially the sodium is present in the glass and the potassium is present in the bath, allows to stiffen the external surface of the glass, collaterally increasing its impact strength.

Advantageously, as an alternative to copper sulfate, said tinting salt is silver nitrate.

Advantageously, the temperature of the bath is selected in an interval comprised between 400° C. and 500° C. Preferably, the temperature of the bath can be approximately 410° C.

Advantageously, the concentration of the salt is selected in an interval comprised between 0.1% and 10% by weight with respect to the total weight of the bath. Preferably, the salt concentration can be approximately 1.7%.

Advantageously, the duration of the immersion of the lens in the bath is selected in a time interval comprised between 1 minute and 10 hours. Preferably, the duration can be approximately 2 hours or approximately 4.5 hours.

Advantageously, the bath further comprises sodium nitrate.

Advantageously, the bath further comprises potassium nitrate.

For example, the bath can be a bath at concentrations comprised between 0.1% and 10% of silver nitrate in potassium nitrate or in sodium nitrate.

The method for tinting lenses can also comprise the immersion of the lens in a tempering bath which comprises at least potassium nitrate. In this manner, the lens can be not only tinted but also tempered in two different steps.

Advantageously, the temperature of the tempering bath is selected in an interval comprised between 400° C. and 500° C. and preferably equal to approximately 450° C., while the duration of the immersion of the lens in the tempering bath is selected in a time interval comprise between 8 hours and 18 hours and preferably equal to approximately 9 hours or approximately 16 hours.

The chemical tempering process, in fact, by means of the interaction of the hot glass with molten potassium nitrate, utilizes the sodium-potassium ion exchange, in which initially the sodium is present in the glass and the potassium is present in the bath, and allows to stiffen the external surface of the glass, collaterally increasing its impact strength.

Advantageously, the tinting bath can further comprise potassium nitrate.

The immersion of the lens in the bath comprising said tinting salt, for example silver nitrate, and potassium nitrate achieves simultaneously a lens tempering and tinting effect.

In this manner, the tinting and tempering of the lens can occur in a single step.

Therefore, method for tinting glass lenses occurs in a bath that comprises potassium nitrate, i.e., in a single step, the duration of the immersion of the lens in the bath can be selected in a time interval comprised between 6 hours and 18 hours and preferably equal to approximately 9 hours or approximately 16 hours.

Furthermore, the concentration of said tinting salt is selected in an interval comprised between 0.1% and 2% by weight with respect to the total weight of the bath and preferably comprised between 0.2% and 0.5% by weight and more preferably equal to approximately 0.4%.

When the method for tinting glass lenses occurs in a bath that comprises potassium nitrate, i.e., in a single step, the temperature of the bath is selected in an interval comprised between 410° C. and 550° C., and preferably around 420° C.

Advantageously, the lens tinting bath and optionally also the tempering bath are kept under agitation. Likewise, the lens can be kept under agitation inside the bath.

Furthermore, the immersion of the glass lens in the bath can comprise the introduction and extraction of the lens in a gradual matter in order to obtain a lens with graduated tinting.

The method for tinting glass lenses can also include thermal pre- and post-treatments in air or in a controlled atmosphere. For example, it is possible to provide a thermal treatment in an oxidizing or reducing atmosphere to further increase the range of colors that can be obtained by means of the described processes. As a further example, it is possible to provide a treatment for hydro- or oleophobic finishing of the lens.

Advantageously, it is possible to combine the described processes in order to increase the obtainable tints. For example, it is possible to combine silver nitrate tinting with copper sulfate tinting. As a further example, it is possible to combine silver nitrate tinting or copper sulfate tinting with thermal post-treatment in an oxidizing or reducing atmosphere. As a further example, it is possible to combine in sequence the treatments described above.

Advantageously, all types of glass can be subject to the tinting method according to the invention. For example, glass provided with UV400 production lends itself to tinting by means of the methods according to the invention.

The method for tinting glass lenses can also be used to tint glass wafers, which are lapped, for example to approximately 1 mm in thickness against the 1.8-2.2 mm that are typical of lenses, to then be glued to a second wafer. This allows to add different functionalities to the lens by means of the selection of the second wafer, the interposition of functional films between the two wafers, and the selection of the adhesive and optional addition of additives thereto.

The present invention also relates to a glass lens that is tinted by means of a method for tinting glass lenses as described above.

The lens can be derived from the assembly of a glass component, for example a wafer, which is tinted by means of the method described above with a second component, for example another wafer. Advantageously, one of the two components can be a photochromic wafer. Advantageously, a polarizing film can be interposed between the two components.

Equally advantageously, the two components can be held together by an adhesive which also comprises an ultraviolet ray absorber or comprises pigments adapted to give chosen optical properties to the lens.

Furthermore, it is possible to apply PVD treatments with solid or graduated tinting to one of the two components of the lens.

It should be understood that the characteristics of embodiments described with reference to an aspect of the present invention are to be considered valid also as regards the other aspects of the invention described herein even if they are not repeated explicitly.

### EXAMPLE 1

A UV400 glass lens is tempered for 9 hours at 450° C. in a potassium nitrate bath and is then tinted by immersion in a bath with 48% copper sulfate in sodium sulfate for 30 minutes at 530° C. in order to obtain a lens with a solid tinting that is different from the original one.

### EXAMPLE 2

A UV400 glass lens is tempered for 9 hours at 450° C. in a potassium nitrate bath and is then tinted by immersion in a bath with 1.7% silver nitrate in potassium nitrate for 2 hours at 410° C. to obtain a lens with a solid tinting that is different from the original one.

### EXAMPLE 3

A UV400 glass lens is tinted by immersion in an agitated bath with 1% silver nitrate in sodium nitrate for 1 hour at 400° C. and is then tempered for 16 hours at 450° C. in a potassium nitrate bath, in order to obtain a lens with a solid tinting that is different from the original one. A hydro- or oleophobic finishing treatment is applied to the lens.

### EXAMPLE 4

A glass lens with UV400 protection is tempered for 16 hours at 450° C. in a potassium nitrate bath and is then tinted by gradual immersion in (or immersion and gradual extraction from) a bath with 4% silver nitrate in potassium nitrate for 2 hours at 400° C. in order to obtain a lens with graduated tinting.

### EXAMPLE 5

A glass lens with UV400 protection is immersed and kept in motion for 16 hours at 420° C. in a bath with 0.2% silver nitrate in potassium nitrate, undergoing tempering and tinting simultaneously; a graduated treatment is applied by PVD to the concave side of the resulting lens.

### EXAMPLE 6

A UV400 glass lens is lapped to 1 mm in order to constitute a wafer, is tempered for 16 hours at 450° C. in a bath of potassium nitrate and is then tinted by immersion in a bath with 4% silver nitrate in potassium nitrate for 2 hours at 420° C. The resulting wafer is used to produce a laminated lens by adhesive bonding with a second wafer optionally provided with further characteristics (IR protection, contrast enhancement, photochromic treatment).

### EXAMPLE 7

A UV 400 glass lens is lapped to 1 mm to constitute a wafer and is immersed for 12 hours at 420° C. in a bath with 0.5% silver nitrate in potassium nitrate, undergoing tempering and tinting simultaneously. The resulting wafer is coupled by adhesive bonding with a photochromic front wafer.

### EXAMPLE 8

A glass lens is lapped to 1 mm to constitute a wafer, is tempered for 16 hours at 450° C. in a potassium nitrate bath and is tinted by immersion in a bath with 6% silver nitrate in sodium nitrate for 1 hour at 400° C. The resulting wafer is coupled to a second UV400 wafer with an acrylic adhesive after the interposition of a functional film (for example a polarizing one). An antiglare treatment is optionally applied to the rear surface by PVD.

### EXAMPLE 9

A glass lens is lapped to 1 mm to constitute a wafer, is tempered for 16 hours at 450° C. in a potassium nitrate bath and is tinted by immersion in a bath with 6% silver nitrate in potassium nitrate for 2 hours at 400° C. The resulting wafer is coupled to a second wafer by means of a polyurethane adhesive by including a UV absorbing agent in the adhesive.

### EXAMPLE 10

A UV400 glass lens is lapped to 1 mm in order to constitute a wafer, is tinted by immersion in a bath with 1% silver nitrate in potassium nitrate for one hour at 400° C. and is then tempered for 16 hours at 450° C. in a potassium nitrate bath. The resulting wafer is coupled to a second wafer with a polyurethane adhesive modified by including in the adhesive pigments/colors adapted to give the lens desired optical properties.

### EXAMPLE 11

A UV400 glass lens is lapped to 1 mm in order to constitute a wafer, is tinted by immersion in a bath with 4% silver nitrate in potassium nitrate for 2 hours at 420° C. The resulting wafer is coupled to a second wafer by means of an epoxy adhesive after the interposition of a functional film (e.g., a polarizing one); before or after coupling, a solid or graduated treatment is applied to one or more surfaces of the wafers by PVD.

In practice it has been found that the method for tinting glass lenses according to the present invention achieves the intended aim and objects, since it allows to tint glass lenses in a manner that is various, controllable, simple, reliable and cheap.

Another advantage of the method for tinting glass lenses according to the invention resides in that it is possible to perform simultaneously tempering and tinting of the lenses in a single tinting and tempering bath.

A further advantage of the method according to the invention resides in that it is possible to obtain a wide variety of tints of the glass lens by selecting appropriately the temperature and duration parameters of the tinting bath and of the concentration of the tinting salt.

The method for tinting glass lenses thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to the requirements.

The disclosures in Italian Patent Application No. 102016000043786 (UA2016A002996) from which this application claims priority are incorporated herein by reference.

1-23. (canceled)

24. A method for tinting glass lenses, comprising the immersion of a glass lens in a bath comprising at least one salt constituted by a cation selected from the group constituted by an alkaline metal, an alkaline earth metal, a transition metal, a metal of the p block of the periodic table, a rare earth metal, and by an anion selected from the group constituted by a halide, a sulfate, a nitrate, the temperature of said bath being selected in an interval comprised between 350° C. and 650° C., the duration of the immersion of said lens in said bath being selected in a time interval comprised between 1 minute and 20 hours, the concentration of said at least one salt being selected in an interval comprised between 0.1% and 70% by weight with respect to the total weight of said bath, the selection of said temperature, of said duration of the immersion and of said composition determining the intensity of the tinting of said lens.

25. The method for tinting glass lenses according to claim 24, wherein said at least one salt is silver nitrate.

26. The method for tinting glass lenses according to claim 24, wherein said at least one salt is copper sulfate.

27. The method for tinting glass lenses according to claim 24, wherein the temperature of said bath is selected in an interval comprised between 400° C. and 500° C.

28. The method for tinting glass lenses according to claim 24, wherein the temperature of said bath is selected in an interval comprised between 500° C. and 600° C.

29. The method for tinting glass lenses according to claim 24, wherein the concentration of said at least one salt is selected in an interval comprised between 1% and 10% by weight with respect to the total weight of said bath.

30. The method for tinting glass lenses according to claim 24, wherein the concentration of said at least one salt is selected in an interval comprised between 30% and 70% by weight with respect to the total weight of said bath.

31. The method for tinting glass lenses according to claim 24, wherein the duration of the immersion in said bath is selected in a time interval comprised between 1 minute and 20 hours.

32. The method for tinting glass lenses according to claim 24, wherein said bath further comprises sodium nitrate or potassium nitrate or sodium sulfate.

33. The method for tinting glass lenses according to claim 24, further comprising the immersion of said glass lens in a tempering bath that comprises at least potassium nitrate.

34. The method for tinting glass lenses according to claim 33, wherein the temperature of said tempering bath is selected in an interval comprised between 400° C. and 500° C., and wherein the duration of the immersion in said tempering bath is selected in a time interval comprised between 8 hours and 18 hours.

35. The method for tinting glass lenses according to claim 24, wherein said bath further comprises potassium nitrate, the immersion of said lens in said bath comprising said at least one salt and said potassium nitrate achieving a tempering and tinting effect on said lens.

36. The method for tinting glass lenses according to claim 35, wherein the duration of the immersion in said bath is selected in a time interval comprised between 8 hours and 18 hours.

37. The method for tinting glass lenses according to claim 35, wherein the duration of the immersion in said bath is selected in a time interval comprised between 12 hours and 16 hours.

38. The method for tinting glass lenses according to claim 24, wherein the concentration of said at least one salt is selected in an interval comprised between 0.1% and 2% by weight with respect to the total weight of said bath.

39. The method for tinting glass lenses according to claim 24, wherein the concentration of said at least one salt is selected in an interval comprised between 0.2% and 0.5% by weight with respect to the total weight of said bath.

40. The method for tinting glass lenses according to claim 24, wherein the concentration of said at least one salt is 0.4% by weight with respect to the total weight of said bath.

41. The method for tinting glass lenses according to claim 24, wherein the temperature of said bath is selected in an interval comprised between 410° C. and 550° C.

42. The method for tinting glass lenses according to claim 35, wherein after the tinting process a thermal treatment in an oxidizing or reducing atmosphere is performed.

43. The method for tinting glass lenses according to claim 42, wherein tinting with silver nitrate, tinting with copper sulfate and thermal treatment in an oxidizing or reducing atmosphere are combined at will.

44. The method for tinting glass lenses according to claim 24, wherein said bath is kept under agitation.

45. The method for tinting glass lenses according to claim 24, wherein said immersion of said glass lens in said bath comprises the introduction and extraction of said lens in and from said bath in a gradual manner in order to obtain a lens with graduated tinting.

46. A glass lens, wherein it is tinted by means of a method for tinting glass lenses according to claim 24.
